(19) United States
(12) Patent Application Publication
(10) Pub. No.: US 2020/0196539 A1
(43) Pub. Date: Jun. 25, 2020

(54) DEVICE FOR SEEDING A CLOUD CELL

(71) Applicant: SELERYS, Rousset (FR)

(72) Inventor: Philippe CARDI, Rousset (FR)

(73) Assignee: Selerys, Rousset (FR)

(21) Appl. No.: 16/619,674

(22) PCT Filed: Jun. 6, 2018
(86) PCT No.: PCT/FR2018/051312

§ 371 Date: Dec. 5, 2019

(30) Foreign Application Priority Data
Jun. 6, 2017 (FR) 1754989

(51) Int. Cl. A01G 15/00

(52) U.S. Cl. CPC A01G 15/00; F42B 12/50

(57) ABSTRACT

The invention relates to a device for seeding a cloud cell, comprising a pyrotechnic torch containing an active substance. The invention further relates to a pneumatic projection apparatus for projecting such a device, the apparatus comprising a guide element and a fastener, which fastener is arranged to cooperate with the distal portion of a projection base of the device. The invention also relates to a system for seeding a cloud cell.

The invention relates to the field of devices for use in the prevention and/or disturbance of meteorological and microphysical equilibria. Devices of this kind are used for all types of use, and preferably but not in a limiting manner for ensuring functions of seeding of a cloud cell, also known as “cloud seeding.”

In the remainder of the document, the invention will be described, preferably but not in a limiting manner, within the context of prevention of hail, i.e. within the context of actions aiming to reduce or abort the phenomena of hail generation on sensitive land areas, such as cultivated regions.

At present, global warming, or more generally climate change, is the central point of many discussions. Such climate change relates in particular, but not in a limiting manner, to the agricultural field, which is affected in particular by sudden meteorological changes. In some regions, such as Africa or Asia, the water resources have reduced considerably in recent years. Furthermore, the water supply problems have worsened the situation. Moreover, in other land areas, for example in Europe, some farmers are affected by sudden falls of hail on their farms, said falls being capable of causing considerable damage, and even of compromising future harvests. The same is true of snow, which sometimes falls unexpectedly in spring, destroying all or some of crops that are in full bloom or fruit formation.

The majority of meteorological phenomena, such as, by way of non-limiting example, rain, hail or snow, are generally due to supercooling of the water within the cloud cells, or more generally within the atmosphere. A cloud cell is initially and essentially composed of droplets of liquid water in suspension in the atmosphere. Indeed, the sun, by means of its irradiation, vaporizes the liquid water resources. The hot air that is thus formed and present in the atmosphere consequently contains water vapor which, due to its low density, increases in altitude. While rising, the pressure reduces, and the hot air previously formed cools again. Gradually, said air condenses into droplets around fine particles present in the atmosphere, and agglomerates in order to form a cloud cell. Said cloud cell moves and can cause rain, snow or even hail to form. When a cloud cell reaches a zone or region where a temperature of for example between 0 and −35° C. prevails, ice crystals form in the cloud cell, from ice nuclei, also known as “freezing nuclei.” The water droplets present within the cloud cell are close to said ice crystals. Water droplets of this kind thus migrate towards said ice crystals. Said crystals increase in size until they become snowflakes within the cloud cell. Depending on the outside ground temperature, snowflakes of this kind, when they fall, turn into rain, for example in summer, or remain in the form of snow, for example in winter. As for the formation of hail, this results from the ice crystal growth process, in the presence of updrafts or hot air currents that are sufficiently strong that they keep the crystals in suspension in the cloud cell. Such cloud cells are referred to as “cumulonimbus.” Thus, in the presence of updrafts, the supercooled air droplets are pushed towards the highest region of the cloud cell, and thus the coldest region, where the ice crystals are located. Said droplets then mix with said crystals and form hailstones. Said hailstone can, in turn, be carried by the updrafts. Other ice crystals thus bind to the hailstones, and thus cause the size of the hailstones to increase. When the size no longer allows the hailstones to be contained within the cloud cell, said hailstones fall to the ground.

Due to the significant damage that a falls of rain, snow or even hail can cause, various researchers have attempted to find methods or processes intended for disturbing the microphysical equilibria in order to influence the processes of precipitation formation, and to thus modify the climate.

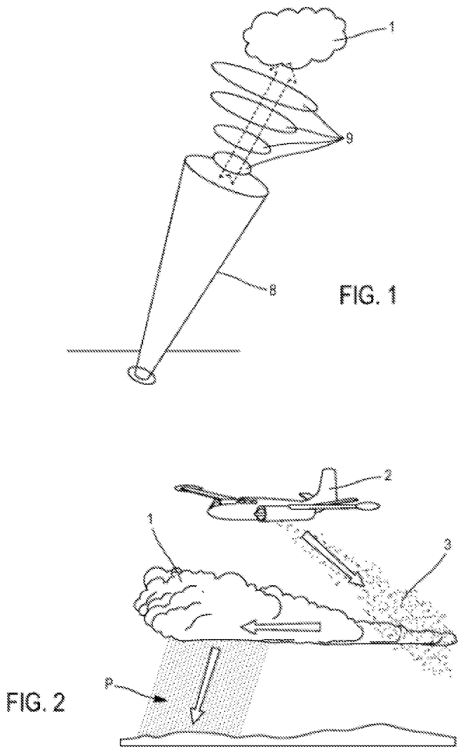

A first technique, which is relatively old as it dates from the end of the nineteenth century, led to the development of a hail cannon. The principle of a system of this kind initially consisted in making use of the smoke projected by firing a cannon. The first experiments tended to demonstrate that the smoke particles functioned as condensation nuclei for forming droplets. Other people considered a second hypothesis, based on the effect of a whirlwind rising in a cloud, creating a disturbance in the formation of hailstones. A third, more recent, hypothesis that is advantageously illustrated in FIG. 1 consists in allowing only a portion of the shockwaves 9, generated by firing of a cannon 8, to propagate in a target cloud cell 1, thus causing a chain reaction of microexplosions that destabilize the crystals being formed, following a polarity mixture in the cloud cell, accompanied with fragmentation of embryonic hailstones. Cannons 8 of this kind were supplied with gunpowder, or even explosive gas such as acetylene, in order to increase the firing frequency. At present, it has not been possible to provide any evidence demonstrating the effectiveness of solutions of this kind.

A second technique has been drawn up, breaking with the precedent of a hail canon, a second technique of this kind not necessarily producing smoke or shockwaves. These are methods known as seeding methods. By way of non-limiting examples, such methods make it possible to increase the condensation of water vapor into liquid water available in a cloud cell. Thus, it is possible to increase or reduce the size and/or the number of droplets present within said cloud cell. Such methods can cause precipitation or, in a variant, falls of hail, on demand. In order to achieve this, particles, which may be artificial, or active substances, also known as “artificial freezing nuclei” are introduced within a cloud cell in order to alter, disturb, or even modify, the exchanges between the different states of the water, for example by accelerating the growth of particular droplets or the solidification of said droplets into ice crystals. Throughout the document, the terms “agent,” “particle” or “active substance” will be used without distinction, in order to define physicochemical elements responsible for the seeding. Said particles or active substances preferably have a strong affinity with water. Furthermore, depending on the type of action or the altitude desired, possibly depending on local conditions, different types of active substances can be used. In general, for cold regions, such as regions located at over three thousand meters of altitude, such particles can advantageously, but in a non-limiting manner, consist of ice nuclei, such as silver iodide or even copper iodide. The use of silver iodide is of particular interest, and is therefore preferred, because this is a particle that is particularly effective from −5° C., in small quantities. In a variant or in addition, other researchers recommend, for example for regions referred to as hot, hygroscopic salts, for example in the form of sodium, calcium or magnesium salts, or even alginates. In a variant, particles of this kind may even consist of cooling materials, such as dry ice, which act around −35° C., thus allowing for crystallization of the supercooled water, and thus achieving an effect similar or identical to that of silver iodide. Furthermore, in a variant or in addition, such cooling materials may be propane or liquid nitrogen. Preferably, but in a non-limiting manner, such particles are generally diffused by means of aerosols. The presence of updrafts within the cloud cell can significantly increase the effectiveness of particles or agents for seeding. Indeed, the updrafts carry along and suck up the particles in order that said particles disperse within the cloud cell, reaching the supercooled water and encountering the ice crystals or hailstones.

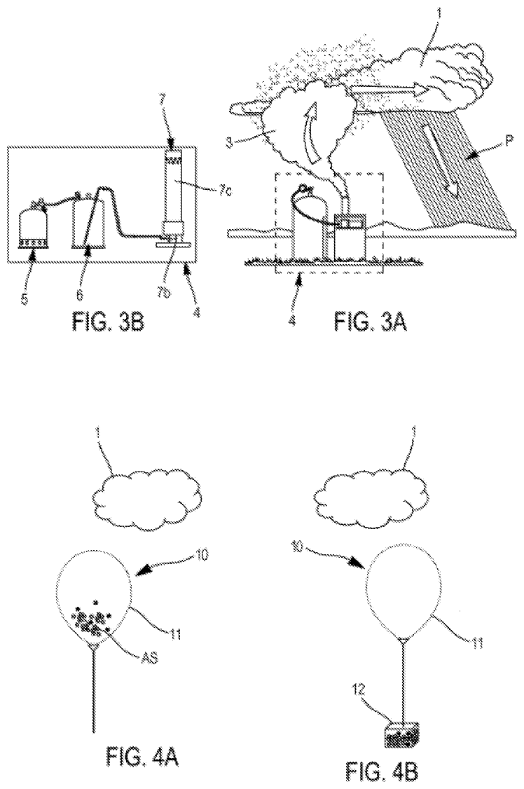

In order to ensure good diffusion of such particles, whatever their composition, various techniques and systems can be used. FIGS. 2, 3A and 3B show first and second embodiments, respectively, of known devices for seeding a cloud cell.

First of all, seeding of a cloud cell can be achieved aerially, for example by means of an aerial device. This first embodiment is described in conjunction with FIG. 2. An aerial device can advantageously consist of an airplane 2 that is adapted for seeding a cloud cell 1. An aerial device of this kind can advantageously be equipped with devices for seeding a cloud cell 1 in the form of particle diffusers 3 (not shown in FIG. 2), said diffusers being, for example, positioned in the region of the wings when the aerial device is the airplane 2. The pilot (not shown in FIG. 2) of such an airplane can, on command, deliver particles to the base of a cloud cell 1 or onto the flank of said cloud cell 1. Such a maneuver may be difficult, considering air currents or significant turbulence. Such seeding processes thus require experienced and skilled pilots. When it is necessary to treat a plurality of cloud cells simultaneously, a plurality of aerial devices is required, considerably increasing the cost of such a solution. Furthermore, aerial devices of this kind cannot travel freely; they must follow and respect the air traffic regulations applicable in the territories over which they are flying, in particular according to precise flight time slots. Therefore, operations of this kind bring about technical constraints, and consequently greater expertise, and thus significant financial costs, for uncertain effectiveness.

In order to attempt to reduce the costs of seeding of a cloud cell, other device have been specially designed, in the form of “anti-hail” rockets, within the context of hail prevention, generally referred to as “explosive rockets.” Such rockets can possibly be launched from the ground. In a variant, such rockets can advantageously be installed on aerial devices, such as that described in conjunction with FIG. 2, advantageously above or below the wings of the airplane 2, for example. During takeoff of the aerial devices, said rockets are subsequently propelled, like a missile, into the center of a cloud cell. The effectiveness of said rockets may, however, depend on the presence of updrafts, which may compromise the propagation of the particles within the cloud cell. Using one or more pyrotechnic rockets for seeding a cloud cell has other disadvantages. On the one hand, there are several dangers linked to using explosive devices, in particular due to a rocket engine and an explosive charge, accompanied by a detonator, being present at the same time, which, in a plurality of use cases, requires strict pyrotechnic standards to be applied. Furthermore, when rockets of this kind are launched from an aerial device or from territories affected by air traffic it is necessary to ensure that existing air traffic rules are complied with. A seeding attempt may thus be delayed or postponed, ultimately rendering such a use very difficult. In addition to problems relating to standards and security, firing rockets does not always ensure sufficient and ecological propagation of the particles within a target cell. The effectiveness of said rockets is therefore low, because it is impossible to guide, i.e. to modify, the trajectory of the rocket once said rocket has been launched.

It is possible, in a variant, that aerial devices may be equipped with booms and torches comprising hygroscopic salts (not shown in FIG. 2) which are also referred to as “torch and parachute rockets.” Such rockets are associated with disadvantages similar to those of the rockets described above, in particular with respect to security standards.

In view of the disadvantages of the devices for seeding a cloud cell in connection with aerial devices and/or rockets such as described in conjunction with FIG. 2, other researchers recommend using terrestrial devices for seeding a cloud cell, said devices being in the form of burners on the ground, also known as “vortex generators” or “ice particle generators.” Known terrestrial devices of this kind for seeding a cloud cell are described in conjunction with FIGS. 3A and 3B. A terrestrial device or vortex generator 4 of this kind, which is specially adapted for seeding a cloud cell 1, comprises a compressed-air cylinder 5, a tank 6 comprising a solution that contains acetone and silver iodide, said tank 6 being in fluid communication with the compressed-air cylinder 5 by means of one or more ducts and/or vanes that are suitable for regulating the pressure of the compressed air prevailing in the ducts. The terrestrial device 4 further comprises a combustion chamber 7 comprising a cylindrical chimney 7c at the base of which a burner 7b is positioned. The combustion chamber 7 furthermore cooperates with the acetone and silver iodide solution tank 6. The operating principle of a terrestrial device 4 of this kind is as follows: the acetone and silver iodide solution is pressurized by means of the compressed air contained in the cylinder 5 and a pressure-reducing valve within the tank 6. Subsequently, said solution of acetone and silver iodide is vaporized, and then sprayed within the combustion chamber 7 by means of a jet (not shown in FIGS. 3A and 3B), and finally ignited by the burner 7b in order to rise up in the atmosphere and subsequently allow for seeding of the cloud cell 1.

However, said terrestrial devices are also associated with some disadvantages. Firstly, since a device of this kind is positioned on the ground, the diffusion of particles, such as silver iodide, for seeding a cloud cell, is subject to significant constraints and obstacles present on the surface of the earth, such as trees or even buildings, which thus alter or prevent the diffusion of the particles within the cloud cells. Furthermore, such diffusion of particles is very often imprecise, in the manner of the hail canons, since the terrestrial devices are generally positioned in a stationary manner, at a relatively large distance from the cloud cells that are intended to be seeded, said distance being of the order of from a few hundred to a few thousand meters. The presence of air currents or winds can thus deflect the trajectory of the particles, compromise any possibility of seeding, and furthermore bring about contamination of environments located close to said terrestrial devices, by means of the particles thus diffused. Furthermore, due to the presence thereof on the ground, and its bulk, it is very often impossible to quickly move a terrestrial device of this kind according to the formation or movements of a cloud cell. Ultimately, the operating process imposed by using a terrestrial device of this kind results many disadvantages. Currently, the known terrestrial devices lack means for following the trajectory and/or diffusion of the particles. It is therefore not possible to verify if, in a non-limiting manner, said particles have risen in the atmosphere and if they have dispersed correctly within the cloud cells to be seeded. It is therefore not possible to estimate the effectiveness of using a device of this kind.

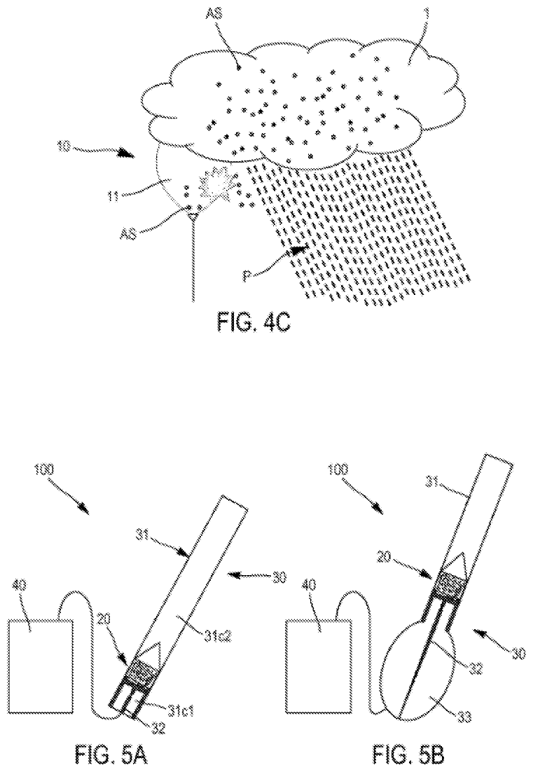

Alternatively, in order to make it possible to prevent hail and to attempt to overcome the various disadvantages mentioned above, other diffusion vectors have been designed. By way of example, as FIGS. 4A, 4B and 4C describe, the diffusion vectors 10 of an active substance AS may comprise aerostatic means. These are for example balloons 11 that are loaded in order to convey said active substance AS directly, as described in FIG. 4A, or indirectly, by means of a receptacle 12, as indicated in FIG. 4B. Said active substance can thus be released in a cloud cell 1, as indicated in FIG. 4C, causing a shower of rain P. This type of solution is particularly advantageous because it is not very labor-intensive and is ecological. However, this can sometimes prove to be imprecise, because the balloons may have deviated from their respective trajectories, under the effect of strong winds, in particular downdrafts. As a result, determining the optimum location for launching balloons of this kind may be particularly complicated to implement, in particular when the seeding has to take place quickly, during a short time window, in order to attempt to maximize the success of the hail prevention operation. Ultimately, there are therefore no effective solutions for quickly overcoming the disadvantages of the known devices for combatting hail, by seeding or wave propagation, or even smoke.

The invention makes it possible to overcome all or some of the disadvantages of the known solutions.

Of the various advantages offered by a device for seeding a cloud cell according to the invention, it can be noted that said device:
offers a more precise seeding process by using a device that projects a diffusion vector of an active substance within the cloud cell, the trajectory and the dispersion of which can be controlled;
proposes a simple, possibly mobile, device;
guarantees targeted action, by means of seeding closer to the cloud cell to be treated, avoiding any contamination of the nearby environment;
overcomes problems of standards and security constraints already mentioned and caused by the solutions currently used, by eliminating in particular any risks during transport.

For this purpose, in particular a device for seeding cloud cells is proposed, comprising a pyrotechnic torch containing an active substance and comprising a detonator, said device further comprising trigger means that are designed for bringing about actuation of the detonator, and thus a diffusion of the active substance by means of the torch, said trigger means cooperating with the detonator of said torch. In order to ensure the projection of a device for seeding a cloud cell, the torch of a device for seeding a cloud cell according to the invention cooperates in an integral manner with the proximal portion of a projection base, said base comprising a proximal portion that is designed to cooperate, by means of a mechanically fitted connection, with a pyrotechnic torch, and to obstruct an opening made in an end of an element for guiding a projection apparatus, and also a distal portion that is designed to cooperate, by means of a mechanically fitted connection, with a fixing means provided within the guide element of said projection apparatus.

Preferably, but in a non-limiting manner, in order to facilitate the manufacture of a device for seeding a cloud cell according to the invention, the torch and the base can form one single physical entity.

In a variant or in addition, in order to ensure the integrity of the active substance before the diffusion thereof, and an optimum trajectory of a device for seeding a cloud cell according to the invention, said device may comprise a shroud element that cooperates in an integral manner with the torch or that forms one physical entity, together with said torch, the outer casing of which is arranged so as to improve the aerodynamism of said torch.

In order to ensure optimum seeding of a cloud cell, preferably but in a non-limiting manner the active substance of a device for seeding a cloud cell according to the invention may be formed primarily of silver iodide or a hygroscopic salt.

In order to guarantee that the trajectory of a device for seeding according to the invention is followed, the pyrotechnic torch thereof may also comprise propagation marker particles, which particles can be detected by any suitable analysis means.

According to a first variant, the detonator of the torch of a device according to the invention may be mechanically controlled, and the trigger means may comprise a firing pin.

According to a second variant, the detonator of the torch of a device according to the invention may be pyrotechnically controlled, and the trigger means may comprise a squib in the form of a delay detonator.

According to a third variant, the trigger means of a device for seeding a cloud cell according to the invention may comprise a processing unit, said processing unit being arranged so as to draw up and generate an actuation command intended for the detonator of the pyrotechnic torch, in accordance with a specified trigger event. According to this embodiment, the detonator of such a device may be electrically controlled and capable of interpreting the commands generated by the trigger means.

Preferably, but in a non-limiting manner, the trigger means of a device for seeding a cloud cell according to the invention may furthermore comprise a sensor that cooperates with said processing unit and that provides said processing unit with a measure of a physical magnitude that represents the altitude or the speed and/or the acceleration of the torch. Said processing unit of the trigger means can thus be arranged so as to compare the measure of the physical magnitude with a predetermined threshold, and the trigger event may consist in a comparison demonstrating a measure of said physical magnitude that is substantially equal to said specified threshold.

Preferably, the sensor of the trigger means of a device for seeding a cloud cell may comprise an altimeter, an accelerometer and/or a gyroscope.

In a variant or in addition, the processing unit of the trigger means of a device for seeding a cloud cell according to the invention can be arranged so as to cause a meter to move, and to compare the value of said meter with a threshold value, and the trigger event may thus consist in a comparison demonstrating a value of said meter that is equal to the specified threshold.

In order to ensure that the seeding of a cloud cell is followed, a device for seeding a cloud cell according to the invention may comprise a second sensor which cooperates with the processing unit, said second sensor being capable of detecting the propagation marker particles, according to a suitable analysis means.

Preferably but in a non-limiting manner, in order to guarantee an advantageously quick and controlled projection, so as to ultimately allow for a diffusion of an active substance in accordance with a controlled trajectory, even in the presence of downdrafts or updrafts, the projection base of a device according to the invention may comprise a mechanical fuse, said fuse comprising a central portion of which the elastic limit is less than those of the other elements forming the base, said portion being arranged so as to break suddenly when a specified mechanical stress is applied to said portion.

According to a second object, the invention relates to a pneumatic projection apparatus that is designed for projecting a device for seeding a cloud cell according to the invention. In order to achieve this, a projection apparatus according to the invention comprises a guide element having a port, said port being arranged so as to receive the torch of said device for seeding, and having a cross section that is substantially identical to the largest cross section of the external wall of said device, said guide element comprising or cooperating in an integral manner with a fixing means. In order to guarantee an advantageously quick and controlled projection of a device for seeding a cloud cell according to the invention, so as to ultimately allow for a diffusion of an active substance in accordance with a controlled trajectory, even in the presence of downdrafts or updrafts, the fixing means of a projection apparatus according to the invention is arranged so as to cooperate with the distal portion of a base according to the first object of the invention.

In a variant or in addition, the fixing means of a projection apparatus according to the invention may cooperate with the base by means of an interface comprising a mechanical fuse, said fuse comprising a portion that is arranged so as to break suddenly when a specified mechanical stress is applied to said portion.

In order to optimize the feed of a projection apparatus according to the invention, said apparatus can further comprise a pressurized chamber, said chamber cooperating in an integral manner with one of the ends of the guide element.

According to a third object, the invention relates to a system for seeding a cloud cell. A system of this kind for seeding a cloud cell comprises:
a device for seeding a cloud cell according to the second object of the invention;
a projection apparatus according to the third object of the invention, arranged so as to receive said device;
a gas tank that is arranged so as to supply gas to and to pressurize the projection apparatus, said tank cooperating fluidically with said projection apparatus.

Other features and advantages will appear more clearly from reading the following description and studying the accompanying drawings, in which:

FIGS. 1, 2, 3A, 3B, 4A, 4B and 4C, described above, illustrate detailed views of known hail-prevention devices;

FIGS. 5A and 5B show first and second embodiments, respectively, of a system for seeding a cloud cell according to the invention;

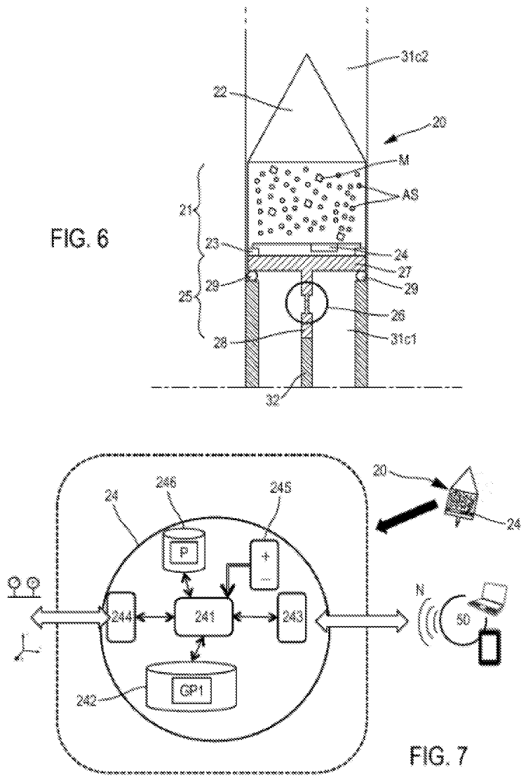

FIG. 6 is a schematic view of a non-limiting embodiment of a device for seeding a cloud cell according to the invention;

FIG. 7 is a schematic view of a non-limiting embodiment of trigger means of a device for seeding a cloud cell according to the invention.

FIGS. 5A and 5B show first and second embodiments, respectively, of a system for seeding a cloud cell according to the invention.

Within the meaning of the invention, and throughout the document, “cloud cell” is intended to mean any cluster or mass of fine droplets of liquid or vaporized water in suspension in the atmosphere, said droplets possibly being kept in suspension as a result of the presence of updrafts. Indeed, when the size of said droplets does not exceed a few microns, said droplets can be kept in suspension naturally.

In order to perform seeding of a cloud cell of this kind, i.e. to disturb the microphysical equilibria within the cell, particles or active substances, also known as “artificial freezing nuclei” when the active substance or substances act in a cold region, are introduced within said cloud cell in order to alter, disturb, or even modify, the exchanges between the different states of the water, for example by accelerating the growth of particular droplets or the solidification of said droplets into ice crystals. As specified above, throughout the document, the terms “active charge,” “artificial particle” or “active substance” will be used to define an agent responsible for seeding a cloud cell.

According to non-limiting embodiments described in connection with FIGS. 5A and 5B, a system 100 for seeding a cloud cell according to the invention comprises a device 20 for seeding a cloud cell and a projection apparatus 30 that is arranged so as to receive and project said device. A projection apparatus 30 of this kind is advantageously described as pneumatic, because the operation thereof is based on the principle of pneumatic energy. Indeed, within a projection apparatus 30 of this kind, a compressed gas is used as a transport and energy storage means. Said projection apparatus 30, just like any other pneumatic system, operates by means of a pressure difference, also referred to as a gradient, between two separate zones or chambers, a pressure difference of this kind then creating a compression force, said force itself bringing about a movement. A device 20 of this kind for seeding a cloud cell, and a projection apparatus 30 of this kind, according to the invention, will be described in greater detail in the following.

In order to ensure optimum operation of said projection apparatus 30, a system 100 for seeding a cloud cell according to the invention also comprises a gas tank 40 that is arranged so as to supply gas to and to pressurize the projection apparatus 30, said tank 40 cooperating fluidically with said projection apparatus 30. The tank 40 is thus in fluid communication with the projection apparatus 30, by means of one or more ducts and/or one or more valves that are suitable for regulating the pressure of the compressed air, or any other gas used in the system, that prevails in said ducts. In a variant or in addition, when a projection apparatus 30 according to the invention comprises a pressurized chamber 33, as indicated in FIG. 5B said system 100 for seeding a cloud cell may also comprise means for regulating the pressure of the gas contained in the chamber, such as, by way of non-limiting example, one or more sensors or pressure sensor, such as a pressure gauge. Furthermore, the gas used within the system 100 for seeding a cloud cell according to the invention may consist of different compositions, containing, for example, compressed air, helium, or any other chemically neutral or non-explosive gas, i.e. any gas of which the composition guarantees absence of any chemical reaction between the gas and a pyrotechnic mixture contained within the device 20 for seeding a cloud cell according to the invention. However, the invention is not intended to be limited to the use of a gas or a specific composition. The selection of one particular gas composition compared with another composition may, advantageously but in a non-limiting manner, depend on the altitude, the trajectory that a device according to the invention should achieve in order to seed a cloud cell in a precise and relevant manner, or to further reduce the investment costs associated with an installation.

FIG. 6 is a schematic view of a non-limiting embodiment of a device 20 for seeding a cloud cell according to the invention.

A device 20 for seeding a cloud cell according to the invention advantageously comprises a pyrotechnic torch 21 containing an active substance AS. A pyrotechnic torch 21 of this kind also comprises a pyrotechnic mixture (not shown in FIG. 6), also referred to as an explosive charge, that allows for combustion of a torch of this kind, and ultimately dispersion of the active substance AS. In order to contain the active substances AS and pyrotechnic mixture, said torch 21 advantageously comprises a container, i.e. any element, object, or physical entity that can accommodate or receive said active substance AS and/or the pyrotechnic mixture or the explosive charge, ultimately ensuring transport and/or delivery of the active substance AS and/or the pyrotechnic mixture of explosive charge as far as a predetermined ideal destination for ensuring the seeding function. A container of this kind, which can also be referred to as the casing, is advantageously sealed, even hermetically, in order to maintain the integrity of the active substance AS, in particular by preventing any unexpected chemical reaction between the active substance AS and the ambient environment around said device before projection of a device of this kind, and finally to allow for optimum application of the seeding methods. The delivery of an integral active substance AS can thus be effectively conveyed to a predetermined altitude or along an established trajectory. In order to achieve this, by way of its composition and/or its physicochemical properties, the material of which the container is mainly formed can advantageously ensure the sealing, or even the hermetic sealing, of said container. Preferably but in a non-limiting manner, in order to facilitate the manufacture of a torch 21 of this kind, a container of this kind may be provided in the form of a tube. However, the invention is not intended to be limited to only this arrangement of the container, it being possible for said container to be adapted depending on the projection apparatus 30 within which it is accommodated. Furthermore, delivery of the active substance AS can be achieved in accordance with various techniques. Among these various techniques, a distinction is in particular and primarily made between two methods: progressive and possibly controlled diffusion, or sudden and instantaneous diffusion. Using a pyrotechnic torch in particular allows for controlled and optimum diffusion of an active substance AS that is necessary for seeding a cloud cell in accordance with the invention. This also has significant advantages from an ecological perspective, since once the seeding has been performed, the pyrotechnic torch is almost entirely consumed, thus leaving only a very small residue. However, the invention is not intended to be limited to the use of a torch of this kind, and, in a variant, could use other types of diffusion mean, such as, by way of non-limiting example, a system in the form of a spray-type diffuser instead and in place of the pyrotechnic torch. A diffuser of this kind could thus directly cooperate, mechanically, pyrotechnically or electrically, with the trigger means of a device for seeding a cloud cell according to the invention, said trigger means being arranged, due to the structure and the mode of operation thereof, to ensure cooperation of this kind. Within the meaning of the present document, the term “pyrotechnic torch” will therefore be interpreted in a broad manner, in order to also denote such other system or diffusers of an active substance AS.

Furthermore, the pyrotechnic torch 21 of a device 20 of this kind comprises a detonator (not shown in FIG. 6). Within the meaning of the invention, and throughout the document, “detonator” is intended to mean any part or any element that is designed for igniting an explosive mixture contained within the pyrotechnic torch and intended for causing the detonation of said mixture. A detonator of this kind may be of different types, such as pyrotechnic, mechanical, electrical, electronic or even chemical detonator, and may be activated or actuated in various manners. In order to achieve this, in order to actuate or activate a detonator of this kind and to finally control the delivery of an active substance AS at a selected altitude and/or in accordance with a specified trajectory, in particular depending on the position of the cloud cell to be seeded, and on the application, a device 20 for seeding a cloud cell according to the invention may further comprise trigger means that are designed for bringing about actuation of the detonator, and thus a diffusion of the active substance AS by means of the torch 21, said trigger means cooperating with the detonator of said torch 21. Trigger means of this kind allow a user of a device 20 according to the invention to actuate the delivery of the active substance AS, at the appropriate time and in accordance with a predetermined trajectory, and ultimately to ensure more effective seeding, by guaranteeing precise, or even optimum, targeting of the cloud cell to be seeded. Three non-limiting examples of trigger means of a device for seeding a cloud cell will be described later in the document. The cooperation between the trigger means and the detonator can be ensured by any element that is capable of associating said means and/or putting them into communication. The cooperation between a detonator of this kind and trigger means of this kind advantageously depends on the respective type and/or structures of said detonator and trigger means. By way of non-limiting example, a cooperation of this kind can advantageously be achieved by a suitable mechanical connection. In a variant, trigger means of this kind and a detonator of this kind can cooperate with the aid of suitable communication means which in particular allow for electrical, magnetic or electromagnetic communication. The invention is thus not intended to be limited to the type of element(s) guaranteeing cooperation of this kind, or even to the respective physical characters of the trigger means and/or of the detonator.

As specified above, a system 100 for seeding a cloud cell according to the invention comprises a device 20 for seeding a cloud cell and a projection apparatus 30 that is arranged so as to receive and project said device. In order to ensure cooperation with a separate projection apparatus and to guarantee projection of a device 20 for seeding a cloud cell according to the invention, the torch 21 thereof cooperates in an integral manner with the proximal portion 28 of the base 25. Within the meaning of the invention, and throughout the document, “base” is intended to mean any part or any element, optionally bulbous, that is used for bearing and/or supporting the pyrotechnic torch 21. By way of advantageous and non-limiting example, described in connection with FIG. 6, cooperation of this kind between a torch 21 and a base 25 can be achieved by means of a mechanically fitted connection, which is advantageously permanent or reversible. A fitted connection of this kind can be achieved by any suitable fixing means, said torch 21 and base 25 being mutually arranged so as to ensure assembly thereof. By way of non-limiting example, said torch 21 may comprise one or more threaded rods, for example one or more screws, designed for being received inside one or more corresponding threaded holes, advantageously made in the base 25. However, the invention is not intended to be limited to this single embodiment. In a variant, according to the invention, the torch 21 and the base 25 of a device 20 for seeding a cloud cell according to the invention can form or consist of one single physical entity. An arrangement of this kind in particular makes it possible to reduce the number of elements that form the device 20 for seeding a cloud cell, the torch 21 and the base 25 being integral, and optionally manufactured from the same material, in order to simplify manufacture and/or installation of said device 20, and ultimately to reduce the manufacturing and/or installation costs.

According to a non-limiting embodiment, described in particular in connection with FIGS. 5A, 5B and 6, in order to ensure the operation of a system for seeding a cloud cell according to the invention, more particularly the projection or propulsion of a device for seeding a cloud cell according to the invention, a projection base 25 for the pyrotechnic torch 21 comprises a proximal portion 27 that is designed to cooperate, in accordance with a mechanically fitted connection, with a pyrotechnic torch. As already mentioned, a fitted connection of this kind can be achieved by any suitable fixing means, said torch 21 and the proximal portion 27 of said base 25 being mutually arranged so as to ensure assembly thereof. In addition, according to FIG. 6, the proximal portion 27 may have a substantially planar surface, in order to facilitate the cooperation of the base with the torch of a device for seeding a cloud cell according to the invention. In a variant or in addition, the proximal portion 27 of the base may also be in the shape of a skirt, in order to ensure the seal during the projection of a device for seeding a cloud cell according to the invention, when said device is projected inside a guide element of a projection apparatus.

Furthermore, the proximal portion 27 of the base 25 is also designed for obstructing an opening made in an end 33 of a guide element 31 of a projection apparatus 30. An obstruction of this kind advantageously makes it possible to create a sealed chamber 31c1 within a guide element 31 of a projection apparatus 32, inside which is a device 20 for seeding a cloud cell, the pressure of which chamber can advantageously be determined and controlled. It will be seen below that the device 20 is projected under the effect of a sudden release of the pressure contained within a chamber of this kind. In order to obstruct said opening that is made in the guide element, the proximal portion 27 of a base 25 according to the invention has dimensions, in particular a cross section, substantially equal to those of the interior wall of a guide element 31 of said projection apparatus, within which said base 25 and said device 20 for seeding a cloud cell, with which device a base of this kind cooperates, are received. In addition, according to the invention the base 25 can cooperate with a seal 29 which makes it possible to reduce, or even prevent, any possible leak of gas within the projection apparatus, and thus increase the effectiveness thereof. According to FIG. 6, a seal 29 of this kind can advantageously be arranged so as to fit the internal wall of a guide element of said projection apparatus, i.e. for example to be circular and toroidal.

In addition, according to FIGS. 5A, 5B and 6, the base 25 for the pyrotechnic torch 21 comprises a distal portion 28 that is designed to cooperate, in accordance with a suitable mechanical connection, with a fixing means 32 that is present within the guide element 31 of said projection apparatus 30. A distal portion 28 of this kind guarantees a fitted connection of a device for seeding a cloud cell, when said device is received within the guide element prior to projection. By way of non-limiting example, a mechanical connection of this kind can advantageously be reversible. However, the invention is not intended to be limited to this single type of connection. A fitted connection of this kind can be achieved by any suitable fixing means, said fixing means 32 and the distal portion 28 of said base 25 being mutually arranged so as to ensure assembly thereof. By way of non-limiting example, a distal portion 27 of this kind can advantageously be equipped with a hooking system of the pneumatic lockable connection type. In a variant, said fixing means 32 may comprise one or more threaded rods, for example one or more screws, designed for being received inside one or more corresponding threaded holes, advantageously made in the distal portion 28 of the base 25.

One of the aims of the invention is that of proposing a device for seeding a cloud cell according, the projection of which is advantageously rapid and controlled, so as to ultimately allow for a diffusion of a substance in accordance with a controlled trajectory, even in the presence of downdrafts or updrafts. In order to achieve this, a base of a device for seeding a cloud cell according to the invention may further comprise a mechanical fuse. Within the meaning of the invention, and throughout the document, “fuse” is intended to mean any part or any element that is arranged so as to break when a significant mechanical stress is transmitted. In accordance with a preferred but non-limiting manner embodiment described in connection with FIG. 6, the mechanical fuse 26 of a base 25 of this kind may comprise a central portion of which the elastic limit is less than those of the other elements forming the base, said portion being arranged so as to break suddenly when a specified mechanical stress is applied to said portion, for example a bearing stress. Generally any material, and therefore the material which, due to the dimensions thereof, forms the central portion of a mechanical fuse 26 of this kind, has an elastic limit. The “elastic limit” is defined as the stress, i.e. the total of the forces applied to the material forming the central portion of a mechanical fuse 26 that tend to deform said fuse, due to which stress the material forming said central portion deforms in an irreversible manner until said material breaks. The central portion of a mechanical fuse of this kind thus undergoes plastic deformation until a crack forms on the surface of the portion. As a result of the high tension present at the surface of the material, said crack, when it reaches its maximum speed, subsequently multiplies into a plurality of fractures and spreads over the entire surface of the central portion. Finally, the central portion of the mechanical fuse 26 of said base 25, said base being included within or advantageously cooperating with a device for seeding a cloud cell, suddenly breaks, causing the projection or propulsion of a device of this kind, towards the cloud cell to be treated.

Before the tank and the projection apparatus 30 are put into gas communication, said tank advantageously being designed to supply said projection apparatus with gas, the gas pressure inside the guide element is substantially equal on either side of the base. When the tank supplies the guide element with gas, as described in particular in connection with FIGS. 5A and 5B, the presence or quantity of gas molecules within the chamber 31c1 increases due to the presence of the base 25 obstructing the chamber 31c1 or sealing or hermetically sealing said chamber. Since the base 25 allows for creation of a sealed chamber 31c1 within the guide element, the quantity of gas molecules remains invariable in the second chamber 31c2 of the guide element, a second chamber of this kind comprising an opening through which the gas escapes as soon as the base no longer obstructs said opening upon the sudden break of the mechanical fuse, projecting a device for seeding a cloud cell according to the invention. Indeed, since the collisions of gas molecules within the chamber 31c1 are more and more considerable, and since the material forming the guide element is rigid, and since the mechanical fuse has the lowest elastic limit, said fuse is the first to break suddenly, due to the mechanical stress applied by the pressure, thus allowing for release of the gas molecules, and finally the projection of said device for seeding a cloud cell. Consequently, various criteria may make it possible to control a projection of this kind, and therefore the diffusion of the active substance, as well as the seeding of a cloud cell. Firstly, the material that primarily forms the mechanical fuse, more generally the base, has its own elastic limit. Therefore, depending on the material selected, in particular the composition thereof and the dimensions, for forming the mechanical fuse and more generally the projection base, in accordance with the desired application and/or the altitude of the cloud cell to be treated, it is possible to substantially control the trigger and the delivery of the active substance by substantially “programming” the pressure at which the mechanical fuse will give. The device for seeding a cloud cell will then be propelled, in accordance with a trajectory defined by the impulse thereof at the output of the guide element of the projection apparatus.

Furthermore, in a variant or in addition, according to the non-limiting embodiment described in connection with FIGS. 5A, 5B and 6, a device 20 for seeding a cloud cell according to the invention may comprise a shroud element 22 that cooperates in an integral manner with the torch 21, in accordance with a suitable mechanical connection. By way of non-limiting example, a mechanical connection of this kind can advantageously be of the fitted type, and advantageously permanent. A fitted connection of this kind can be achieved by any suitable fixing means, the shroud element 22 and the pyrotechnic torch 21 being mutually arranged so as to ensure assembly thereof. However, the invention is not intended to be limited to this single type of connection or to the fixing means bringing about said mechanical connection. In a variant, a shroud element 22 of this kind may constitute a single physical entity, together with said torch 21. Said shroud element 22 of a device for seeding a cloud cell according to the invention comprises an outer casing, said casing primarily ensuring two functions. Firstly, it ensures protection of the elements forming the torch, more particularly the integrity of the active substance AS prior to the diffusion thereof. Subsequently, a casing 22 of this kind is arranged, by means of a particular profile or even a specific material, so as to improve the aerodynamism of said device 20 for seeding a cloud cell, more particularly the torch thereof.

In a variant, a mechanical fuse of this kind, as described above, can cooperate or be arranged not in the region of the distal portion of the base, but in the region of the distal portion of a fixing means 32 contained within the projection apparatus 30. In this case, said fuse, at least the portion that remains connected to the fixing means 32 after the projection of the device 20 for seeding a cloud cell, can be removed in order to cooperate with a new fuse for a subsequent projection of a device 20. A cooperation of this kind can be ensured by means of any suitable mechanical connection, as described above, i.e. achieved by a screw system or, in a variant, a pneumatic connection.

Using a mechanical fuse in particular allows for a sudden break, which is necessary for the projection of a device for seeding a cloud cell according to the invention. A slower loss of tightness would reduce the projection power. Today, no valve appears to be capable of resisting the pressure or ensuring such suddenness. The invention thus provides for the presence and use of a “structural” mechanical fuse. In a variant, if researchers were to develop a valve that makes it possible to ensure a sudden break, according to the invention a valve of this kind could be used instead and in place of the fuse described above.

As specified above, said active substance AS must preferably have a strong affinity with water. Depending on the application and the structure of the device 20 for seeding a cloud cell, said active substance AS can be in various forms, generally solid, such as, by way of non-limiting examples, crystals of various sizes, or powders. Using an active substance AS in the form of powders has been found to be of interest, since the delivery, dispersion and/or diffusion thereof can be more easily controlled and/or regulated than the use of an active substance in a liquid form. In addition, delivery of the active substance AS in the form of powders can be achieved in a sudden or progressive manner.

In general, said active substance AS can advantageously, but in a non-limiting manner, consist of ice nuclei, such as silver iodide or even copper iodide. Preferably, the active substance of a device 20 according to the invention may be formed primarily of silver iodide. The use of silver iodide is of particular interest, and is therefore preferred, because this is a particle that is particularly effective at −5° C., in small quantities. However, in many cases silver iodide has been found to be toxic and unecological. In a variant or in addition, the active substance of a device 20 according to the invention may be formed primarily of hygroscopic salts. Indeed, depending on the desired application, due to the high toxicity resulting from the silver iodide, the use of hygroscopic salts, for example in the form of sodium, calcium or magnesium salts, alginates, or even cooling materials such as dry ice, or liquid propane or nitrogen, is preferred.

Furthermore, whatever the configuration of the device 20 for seeding a cloud cell according to the invention, in a variant or in addition the active substance AS of a device 20 according to the invention can be associated with propagation marker particles M that can be detected by any suitable analysis means. Thus, as described in connection with FIG. 6, the pyrotechnic torch 21 may also contain, within it, propagation marker particles M that can be detected by any suitable analysis means. The presence of maker particles M of this kind is particularly clever because said particles allow a user of the device, for example a farmer or any other operator, to observe the propagation of the active substance, and thus to measure or assess the effectiveness of the device for seeding a cloud cell. Particles M of this kind can advantageously be analyzable by any suitable analysis means such as, by way of non-limiting examples, an ultraviolet spectrophotometer or an infrared spectrometer, by absorption or by fluorescence. In a variant, it could possibly be conceivable that the particles M may be colored, in order that they can be detected and/or observed in the visual field, by the naked eye, or even possibly with the aid of a magnifying optical system.

According to a particularly expedient embodiment, marker particles M of this kind may comprise particles, aluminum flakes or filaments, plastics materials, or micro glasses that are highly reflective using radar, which are commonly used within countermeasure systems of the “CHAFF” type.

As already mentioned, the trigger means of a device 20 for seeding a cloud cell according to the invention allow a user thereof to actuate the detonator of a device for seeding a cloud cell according to the invention at the appropriate time, and thereby ensure delivery or diffusion of the active substance AS at a predetermined location and in accordance with a predetermined trajectory, between a minimum altitude and a maximum altitude, corresponding to the aspiration zone of the cloud cell, and ultimately to ensure more effective seeding, by guaranteeing more precise, or even optimum, targeting of the cloud cell to be seeded. Three non-limiting examples of trigger means of a device 20 for seeding a cloud cell according to the invention will be described later in the document.

According to a first embodiment (not shown in the drawings), the detonator of the torch 21 of a device 20 for seeding a cloud cell according to the invention can be mechanically controlled, i.e. actuatable or actuated by means of a mechanical element or part. According to this first embodiment, the trigger means are thus arranged so as to produce one or more mechanical commands, for example a force that then brings about a movement and mechanical contact. By way of example, trigger means of this kind may comprise a percussion system, such as a firing pin, i.e. a metal part, optionally ending in a spike, which, under the action of a previously tensioned spring, strikes the detonator, a detonator of this kind generally consisting in a primer intended for igniting the pyrotechnic mixture responsible for combustion of the torch 21, thus triggering the diffusion of the active substance AS.

In a variant, according to a second embodiment (not shown in the drawings), the detonator of the torch of a device for seeding a cloud cell according to the invention can be pyrotechnically controlled, i.e. actuatable or actuated by means of a pyrotechnic element or part. By way of non-limiting examples, a detonator of this kind may comprise a tube, generally made of aluminum or copper, containing in particular primary and secondary explosive mixtures, as well as a seal foil. The trigger means comprise an igniter in the form of a delay detonator, also referred to as a slow fuse. Once the delay detonator has been activated, the flame conveyed thereby directly initiates the primary explosive mixture.

In a variant, according to a third embodiment that is generally preferred and is described in connection with FIG. 7, the detonator of the torch of a device for seeding a cloud cell according to the invention can be electrically controlled, i.e. actuatable or actuated by means of a specified electrical signal produced by an electrical or electronic element or object. A detonator of this kind is thus responsible for sending an electric pulse which allows for explosion of the explosive mixture, and ultimately ensures the diffusion of the active substance AS. As already mentioned, the trigger means of a device for seeding a cloud cell according to the invention that cooperate with the detonator are advantageously arranged so as to cause the active substance AS to be delivered to a given position and/or altitude. In order to achieve this, according to an advantageous but non-limiting embodiment described in connection with FIG. 7, trigger means 24 of this kind consist of an electronic object. An electronic object of this kind comprises a processing unit 241 in the form, for example, of one or more microcontrollers or microprocessors. A processing unit 241 of this kind is advantageously arranged so as to draw up and generate an actuation command in the form of a specified electrical signal that can be interpreted by a detonator of the pyrotechnic torch in reaction to a specified trigger event, it being possible for said electrical signal to be interpreted by a detonator of this kind as though it were an actuation command thereof.

According to a first non-limiting example, a trigger event of this kind may consist in a comparison demonstrating a measure of a physical magnitude that is substantially equal to a specified threshold. In order to achieve this, the trigger means 24, in the form of the electronic object, may comprise one of more measuring sensors 244 that cooperate with said processing unit 241 and that provide said processing unit with a measure of a physical magnitude GP1 that represents the altitude or the trajectory of the torch 21 of a device 20 for seeding a cloud cell according to the invention. In a variant or in addition, a sensor 244 of this kind can measure the speed or even the acceleration of a torch 21 of this kind. By way of non-limiting examples, a sensor 244 of this kind may consist in one or more altimeters, accelerometers and/or gyroscopes. Said sensor 244 advantageously cooperates with said processing unit 241 by means of internal communication buses, which are indicated in FIG. 7 by single-line, double-headed arrows. The processing unit 241 is thus arranged so as to compare the measure of the physical magnitude GP1 with a predetermined threshold. In order to achieve this, the trigger means or the electronic object 24 comprise a data memory 242 that cooperates with said processing unit 241 by means of internal communication buses, which are indicated in FIG. 4B by single-line, double-headed arrows. Prior to launching the device according to the invention, said predetermined threshold may optionally be entered in the data memory 242. When said measurement reaches said threshold, the processing unit 21 is arranged so as to generate an actuation command, in the form of one or more electrical signals, which command is intended for the detonator and requires controlled triggering of the delivery of the active substance AS. As described above, in order to achieve this the detonator is electrically controlled and capable of interpreting an actuation command generated by the trigger means 24.

In a variant or in addition, according to a second non-limiting example, a trigger event of this kind may consist in a comparison demonstrating a value of a meter that is equal to a specified threshold. The processing unit 241 is arranged so as to cause a meter to move in accordance with a given periodicity, and to compare the value of said meter with the specified threshold value. The parameterization of the value of said threshold and/or that of the update periodicity of said meter makes it possible to program the actuation altitude of the detonator.

In a variant or in addition, in order to prevent any unexpected trigger of the pyrotechnic torch of a device for seeding a cloud cell prior to the projection of said device, according to the invention the trigger event may be generated by or may result from the cooperation between a conductive element outside a device 20 of this kind, with a second conductive element that is positioned in the region of the end of the guide element of a projection apparatus 30 by means of which said device 20 will advantageously be propelled. A trigger event of this kind may thus consist in an electrical signal, for example short-circuiting when the device 20 passes into the projection phase. The processing unit 241 of the trigger means 24 is arranged so as to interpret said electrical signal and generate an actuation command, in the form of one or more electrical signals, which command is intended for the detonator and requires triggering of the delivery of the active substance AS. As described above, in order to achieve this the detonator is electrically controlled and capable of interpreting an actuation command generated by the trigger means 24. By way of non-limiting example, a conductive element of this kind may consist in a conductive ring that is associated with a first element in the form of one or more terminals, or vice versa. In a variant or in addition, according to the invention the trigger event may be produced at the output of the projection apparatus 30, by using a first element and a second element that are arranged at the output of the guide element of the projection apparatus 30 and in the region of the device 20, respectively, in order to form a magnetic contactor that can be interpreted by the processing unit 241.

Furthermore, in order that the electronic object can function in a completely autonomous manner, said object can advantageously comprise an electrical energy source 245, in the form of one or more batteries for example, or even in the form of solar cells that are positioned on the device 20, in the form of a wind energy source, or even in the form of one or more capacitors that have been previously charged and are capable of delivering sufficient electrical energy for allowing the functioning of the electronic object. The ability of an electronic object to function is directly linked to the remaining and available energy capacity of said electronic object.

Furthermore, in a variant or in addition, in order to allow for improved traceability of the seeding of a cloud cell of this kind, a device 20 for seeding a cloud cell of this kind according to the invention may furthermore comprise tracking means (not shown in the drawings) for tracking the trajectory and/or position of said device, said tracking means cooperating with the pyrotechnic torch of said device 20. In order to achieve this, said tracking means, advantageously consisting of a second electronic object, comprise, in a non-limiting manner:
a processing unit;
a sensor for measuring and collecting a physical magnitude relating to the trajectory and/or the position of the device that cooperates with said processing unit;
a data memory that cooperates with said processing unit and into which said processing unit enters the magnitude measured and collected in accordance with a specified periodicity.

The processing units of the trigger means and the tracking means, respectively, advantageously consist of the same physical entity 241. However, the respective processing units of the trigger means may optionally be separate. Furthermore, in the manner of the processing units, said trigger means and said tracking means may optionally be separate.

As described above, tracking and/or trigger mean of this kind comprise a processing unit 241 in the form, for example, of a microcontroller or microprocessor. Said electronic object also comprises a data memory 242, possibly a program memory 246, said memories optionally being separate. The processing unit 241 cooperates with said memories 242 and 246 by means of internal communication buses, which are indicated in FIG. 7 by single-line, double-headed arrows.

As already mentioned, the electronic object also comprises one or more measuring sensors 244 that cooperate with said processing unit 241, the sensor or sensor being arranged so as to measure and collect a physical magnitude GP1 relating to the trajectory and/or the position of the device 20 at a specified time or according to a specified periodicity. A sensor 244 of this kind can measure and gather the acceleration, the position, the trajectory, the altitude, or even the angular speed of a device 20 according to the invention, during the movement thereof in the atmosphere. In order to achieve this, the sensor or sensors 244 may consist of an altimeter, an accelerometer and/or a gyroscope which advantageously cooperate with the pyrotechnic torch in accordance with a mechanical connection. In a variant or in addition to the altimeter, the accelerometer and/or the gyroscope, the sensor or sensors 244 may comprise an inertial unit, generally comprising three gyrometers and three accelerometers, or even a geolocation system of the GPS type (“global positioning system”), said unit and/or said system advantageously cooperating with the torch 21 of a device 20 for seeding a cloud cell according to the invention.

Whatever the type of physical magnitude GP1 measured and gathered, a digital representation thereof is ultimately entered, by the processing unit 241, in the data memory 242 in accordance with a predetermined periodicity. A periodicity of this kind can be defined in advance, prior to launching the device 20, either automatically or manually. By way of non-limiting examples, a periodicity of this kind may be of the order of one or more tens of seconds.

Optionally, the sensor or sensors 244 of the tracking and/or trigger means of a device 20 according to the invention may also be capable of detecting propagation marker particles M in accordance with a suitable analysis means. By way of non-limiting examples, sensors 244 of this kind may optionally be based on detections by means of microwaves, conductivity sensors, vibrating reeds, or even optical and chemical detections. Furthermore, as specified above, marker particles M of this kind can advantageously be traced by any suitable analysis means such as, by way of non-limiting examples, an ultraviolet spectrophotometer or an infrared spectrometer, by absorption or by fluorescence. In a variant or in addition, a device for seeding a cloud cell according to the invention may comprise or cooperate with one or more radar reflectors in order to track the trajectory of said device 20.

In the manner as described above, for the purpose of efficiency, the tracking of the position and/or of the trajectory of a device 20 according to the invention can advantageously be ensured by means of recordings, entered by the processing unit 241 in the data memory 242, of digital representations of the physical magnitude GP1 relative to the trajectory and/or the position of said device 20, measured and gathered in accordance with a specified periodicity. Once the seeding has ended, said measurements are gathered and transferred.

In a variant, it may be possible for the device 20 to be able to communicate and/or transfer a representation of the physical magnitude(s) GP1 measured and gathered in real time. In order to achieve this, the electronic object forming the trigger means and/or the tracking means may comprise communication means 243 that cooperate with the processing unit 241, also by means of internal communication buses. Said communication means 243 can thus ensure communication N, optionally wired or wireless, with any remote electronic entity 50 within communication range. Communication means 243 of this kind can also be of the “long-distance” type, and make it possible for a device 20 of this kind to be able to transmit, to said remote entity 50, all or some of the content of the data memory 242 via messages distributed by a network making use, for example of GPRS, Sigfox or satellite technologies, in the event of said communication taking place wirelessly.

According to another object, the invention relates to a pneumatic projection apparatus 30 that is designed for projecting a device 20 for seeding a cloud cell according to the invention.

As specified above, a projection apparatus 30 of this kind, just like any other pneumatic system, operates by means of a pressure difference, also referred to as a gradient, between two separate zones or chambers, a pressure difference of this kind then creating a compression force, said force itself bringing about a movement or a mechanical stress, allowing for breakage of a mechanical fuse, contained for example by a base according to the invention, and finally the projection of said device 20 according to the invention.

In order to achieve this, according to FIGS. 5A and 5B, a projection apparatus 30 according to the invention comprises a guide element 31. A guide element 31 of this kind advantageously comprises a port. Within the meaning of the invention, and throughout the document, “port” is intended to mean any aperture, any cavity, or any central recess made in the guide element in order to allow for the passage, or retention, even if temporary, therein of a device 20 for seeding a cloud cell according to the invention. A port of this kind is advantageously arranged so as to receive a torch of this kind. Thus, the structural and/or functional arrangement of a device 20 of this kind must be matched primarily to the design of the port made in the projection apparatus 30. In this way, the port advantageously defines a cross section, the dimensions of which are substantially identical to those of the largest cross section of the external wall of the device 20 for seeding a cloud cell. Furthermore, said cross section can advantageously be square, circular, elongate or any other shape capable of being adjusted for the external wall of the casing of a device for seeding a cloud cell, which device is inserted inside a projection apparatus of this kind. By way of preferred but non-limiting example, as described in connection with FIGS. 5A and 5B, such an external wall of the casing of a device 20 of this kind may have a substantially circular cross section, said guide element 31 thus being of a substantially cylindrical or tubular shape. As a result, the port may also have a substantially circular cross section, which is similar to the largest cross section of the external wall of the device 20. Furthermore, a guide element 31 of this kind should advantageously be electrically neutral, in order to avoid any unexpected triggering of the pyrotechnic torch 21 of a device 20 for seeding a cloud cell according to the invention, when said device is installed within the projection apparatus 30. Furthermore, the dimensions, more particularly the size, of the guide element 31 of a projection apparatus 30 according to the invention can influence the more or less sudden release of a device according to the invention. Thus, at a constant pressure, the shorter the guide element the more sudden the release, since the projected device is accelerated only in the guide element.

As mentioned above, one of the aims of the invention is that of guaranteeing the rapid and controlled projection of a device 20 for seeding a cloud cell, so as to ultimately allow for a diffusion of an active substance AS in accordance with a controlled trajectory, even in the presence of downdrafts or updrafts. In order to achieve this, a projection apparatus 30 advantageously comprises one or more fixing means 32 for fixing a device for seeding a cloud cell according to the invention within said projection apparatus. According to a first non-limiting embodiment, described in connection with FIG. 5B, the guide element 31 of an apparatus 30 according to the invention cooperates in an integral manner with a fixing means 32, in accordance with a suitable mechanical connection. By way of non-limiting example, a mechanical connection of this kind can advantageously be of the fitted type, and advantageously permanent. A fitted connection of this kind can be achieved by any suitable fixing means, the fixing means 32 and the guide element 31 being mutually arranged so as to ensure assembly thereof. However, the invention is not intended to be limited to this single type of connection or to the fixing means bringing about said mechanical connection. In a variant, according to a second embodiment described in connection with FIG. 5A, a guide element 31 of this kind may comprise the fixing means and form a single physical entity together with said fixing means 32.

Furthermore, as specified above, a fixing means 32 of this kind is advantageously arranged so as to cooperate with the distal portion 28 of a base 25 according to the invention, in order to ultimately ensure retention of a device 20 for seeding a cloud cell according to the invention, and the controlled projection of said device. According to FIGS. 5A, 5B and 6, the cooperation between the fixing means 32 and the distal portion of the base 25 can be achieved by any suitable mechanical connection. By way of non-limiting example, a mechanical connection of this kind can advantageously be of the fitted type, and optionally permanent. However, the invention is not intended to be limited to this single type of connection. A fitted connection of this kind can be achieved by any suitable fixing means, said fixing means 32 and the distal portion 28 of said base 25 being mutually arranged so as to ensure assembly thereof. By way of non-limiting example, a fixing means of this kind can advantageously comprise a hooking system of the pneumatic lockable connection type. In a variant, said fixing means 32 may comprise one or more threaded rods, for example one or more screws, designed for being received inside one or more corresponding threaded holes, advantageously made in the distal portion 28 of the base 25. Optionally, in a variant or in addition, the fixing means 32 may cooperate with the base by means of a third interface comprising a mechanical fuse. In the manner of the mechanical fuse present within the base, described in connection with FIG. 6, a mechanical fuse of this kind may comprise a central portion of which the elastic limit is less than those of the other elements forming the interface, said portion being arranged so as to break suddenly when a specified mechanical stress is applied to said portion, for example a bearing stress.

As already mentioned, in accordance with the non-limiting embodiments described in connection with FIGS. 5A and 5B, a projection apparatus 30 cooperates fluidically with a gas tank 40 which is arranged so as to supply gas to and pressurize the projection apparatus 30, by means of one or more ducts and/or one or more valves that are suitable for regulating the pressure of the compressed air that prevails in said ducts. According to a first embodiment described in connection with FIG. 5A, a tank 40 of this kind cooperates directly with the guide element 31 of said projection apparatus 30 and thus supplies said guide element 31 without interruption, until there is sufficient pressure within the chamber 31c1 of the guide element. In some cases, a continuous supply of this kind may be associated with some disadvantages, for example with regard to sealing, exhaustion of supplies, or even reliability of the gas supply. In order to mitigate such disadvantages, according to a second embodiment described in connection with FIG. 5B, a projection apparatus 30 according to the invention can furthermore comprise a pressurized chamber 33, thus ensuring that the projection apparatus 30 is pressurized. The guide element 31 of a device according to the invention cooperates in an integral manner with a chamber 33 of this kind, in accordance with a suitable mechanical connection. By way of non-limiting example, a mechanical connection of this kind can advantageously be of the fitted type, and advantageously not permanent, facilitating the insertion of the device 20 according to the invention and the fixing thereof on the fixing means 32. Thus, the guide element 31 can be separated from the chamber 33 in order to “recharge” the projection apparatus 30, said element 31 being put in position again prior to projection of said device 20. A fitted connection of this kind can be achieved by any suitable fixing means, the chamber 33 and the guide element 31 being mutually arranged so as to ensure assembly thereof. However, the invention is not intended to be limited to this single type of connection or to the fixing means bringing about said mechanical connection. In a variant, in order to facilitate the manufacture of a projection apparatus 30 according to the invention, according to a second embodiment described in connection with FIG. 5B, a chamber 33 of this kind may form and constitute a single physical entity together with the guide element 31. According to this second embodiment, the fixing means 32 contained within the projection apparatus can advantageously be contained in or can cooperate with a pressurized chamber 33 of this kind.

As mentioned above, the invention also relates to a system 100 for seeding a cloud cell according to the invention comprises, two non-limiting embodiments of which device are described in connection with FIGS. 5A and 5B. A system according to the invention advantageously comprises a device 20 for seeding a cloud cell according to the invention and a projection apparatus 30 according to the invention that is arranged so as to receive and project said device 20. In order to ensure improved effectiveness of the seeding by means of optimized traceability, said system according to the invention can comprise a remote electronic entity 50 that is capable of communicating with said device 20 via communication means 243 provided within the device 20. An electronic entity 50 of this kind is advantageously capable of receiving and decoding any measurement or item of data relating to the physical magnitude GP1 transmitted by a device 20 for seeding a cloud cell of this kind according to the invention via said communication means of said device 20. By way of non-limiting examples, said remote electronic entity 50 can advantageously consist in a computer, a Smartphone, a tablet, or any other electronic equipment or object that is arranged so as to communicate with the trigger means and/or tracking means of a device 20 according to the invention.

Furthermore, in a variant or in addition, the electronic entity 50 of a system 100 for seeding a cloud cell according to the invention can be arranged so as to read the content of the data memory 242 of said device 20. In order to achieve this, the data memory 242 of a device 20 according to the invention can correspond physically to one or more removable memory cards, for example of the SD (“Secure Digital”) type. According to this arrangement, the electronic entity 50 is thus arranged so as to read and access the content of said memory card. An arrangement of this kind can result from loading a suitable computer program product P into a program memory 246 of said electronic entity 50.

In the same manner, the processing unit 241 of the trigger means and/or the tracking means of a device 20 according to the invention can be arranged so as to produce one or more actuation and/or propulsion commands from the loading, into the data memory 242 or into the program memory 246, which may be separate from the data memory, of a computer program product P comprising one or more program instructions which, when executed or interpreted by said processing unit, cause suitable processes to be implemented.

Furthermore, preferably but in a non-limiting manner, a system 100 for seeding a cloud cell according to the invention can advantageously comprise:
a projection apparatus 30, the guide element of which is of a length of approximately one meter and eighty centimeters;
a device 20 for seeding a cloud cell, the torch 21 of which has a diameter of approximately fifty-five millimeters and a mass of approximately three hundred grams;
a projection pressure of approximately thirty bar that is maintained in the first chamber 31c1 of the guide element 31 of said projection apparatus 30 for approximately thirteen milliseconds.

The invention has been described in the case of the use thereof in connection with applications for seeding cloud cells, in particular in order to prevent hail. Said invention can also be implemented in order to act on any type of meteorological phenomena such as, by way of non-limiting examples, prevention of fog, increase of precipitation in the form of rain, reduction of tropical cyclones, lightning conservation, or even combatting frost. In a variant, the invention can also be used for increasing snowfall, for example in ski resorts, or for storing water in winter in the form of snow.

It is also conceivable that the device 20 according to the invention could guarantee other functions and/or applications than those described and/or mentioned above, such as, by way of non-limiting examples, decontamination or treatment of water present within the cloud cells, or even reducing the acidity thereof. The invention is not intended to be limited to the application within which the device 20 according to the invention is used.

The device 20 according to the invention may also comprise a plurality of active substances AS for acting in different zones of the cloud cell, in accordance with one or more predetermined altitudes, by using one or more suitable active substances. Diffusion of this kind, at various stages, in particular makes it possible to limit the trigger of the diffusion of one or more active substances in zones of less significance.

1. A device for seeding a cloud cell, comprising a pyrotechnic torch containing an active substance and comprising a detonator, said device further comprising a trigger designed for bringing about actuation of the detonator, and thus a diffusion of the active substance by means of the torch, said trigger cooperating with the detonator of said torch, wherein the torch cooperates in an integral manner with the proximal portion (of a projection base, said base comprising:
a proximal portion that is designed for:
cooperating, in accordance with a fitted mechanical connection, with a pyrotechnic torch;
obstructing an opening made in an end of a guide element of a projection apparatus;
a distal portion that is designed for:
cooperating, in accordance with a fitted mechanical connection, with a fastener that is present within the guide element of said projection apparatus.

2. The device according to the claim 1, wherein the torch and the base form a single physical entity.

3. The device according to claim 1, comprising a shroud element that cooperates in an integral manner with the torch or that forms one physical entity, together with said torch, the outer casing of which is arranged so as to improve the aerodynamism of said torch.

4. The device according to claim 1, wherein the active substance is primarily formed of silver iodide or a hygroscopic salt.

5. The device according to claim 1, wherein the pyrotechnic torch also comprises propagation marker particles that can be detected by any suitable analysts analyzer.

6. The device according to claim 1, wherein the detonator of the torch is mechanically controlled, and the trigger comprises a firing pin.

7. The device according to claim 1, wherein the detonator of the torch is pyrotechnically controlled, and the trigger comprises a squib in the form of a delay detonator.

8. The device according to claim 1, wherein:
the trigger comprises a processing unit, said processing unit being arranged so as to draw up and generate an actuation command intended for the detonator of the pyrotechnic torch, in accordance with a specified trigger event;
the detonator is electrically controlled and capable of interpreting the commands generated by the trigger.

9. The device according to claim 8, wherein:
the trigger furthermore comprises a sensor that cooperates with said processing unit and that provides said processing unit with a measure of a physical magnitude that represents the altitude or the speed and/or the acceleration of the torch;
the processing unit is configured to compare the measure of the physical magnitude with a predetermined threshold;
the trigger event comprises a comparison demonstrating a measure of said physical magnitude that is substantially equal to said specified threshold.

10. The device according to claim 9, wherein the sensor comprises an altimeter, an accelerometer and/or a gyroscope.

11. The device according to claim 8, wherein:
the processing unit is arranged configured to cause a meter to move, and to compare the value of said meter with the specified threshold value;
the trigger event comprises a comparison demonstrating a measure of said meter that is equal to said specified threshold.

12. The device according to claim 8, wherein the pyrotechnic torch comprises propagation marker particles that can be defected by any suitable analyzer, and further comprising a second sensor which cooperates with the processing unit, said second sensor being capable of detecting the propagation marker particles, according to a suitable analyzer.

13. The device according to claim 1, wherein the base comprises a mechanical fuse, said fuse comprising a central portion of which the elastic limit is less than those of the other elements forming the base, said portion being arranged so as to break suddenly when a specified mechanical stress is applied to said portion.

14. A pneumatic projection apparatus designed for projecting a device for seeding a cloud cell according to claim 1, comprising a guide element having a port, said port being arranged so as to receive the torch of said device for seeding, and having a cross section that is substantially identical to the largest cross section of the external wall of said device, said guide element comprising or cooperating in an integral manner with a fastener, said fastener being arranged so as to cooperate with the distal portion of said projection base.

15. The projection apparatus according to claim 14, wherein the fastener cooperates with the base by means of an interface comprising a mechanical fuse, said fuse comprising a portion that is configured to break suddenly when a specified mechanical stress is applied to said portion.

16. The protection apparatus according to claim 14, further comprising a pressurized chamber, said chamber cooperating in an integral manner with one of the ends of the guide element.

17. A system for seeding a cloud cell, comprising:
a device for seeding a cloud cell according to claim 1;
a projection apparatus comprising a guide element having a port said port being arranged so as to receive the torch of said device for seeding, and having a cross section that is substantially identical to the largest cross section of the external wall of said device, said guide element comprising or cooperating in an integral manner with a fastener, said fastener being arranged so as to cooperate with the distal portion of said projection base; and
a gas tank that is arranged so as to supply gas to and to pressurize the projection apparatus, said tank cooperating fluidically with said projection apparatus.
